(19) United States
(12) Patent Application Publication
(10) Pub. No.: US 2009/0249188 A1
(43) Pub. Date: Oct. 1, 2009

(54) METHOD FOR ADAPTIVE TRANSCRIPTION OF WEB PAGES

(75) Inventors: Parijat Dube, Yorktown Heights, NY (US); David A. George, Somers, NY (US); Raymond B. Jennings, III, Ossining, NY (US); Malgorzata E. Stys, Purdys, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/056,590

(22) Filed: Mar. 27, 2008

(51) Int. Cl. G06F 17/30

(52) U.S. Cl. 715/234

(57) ABSTRACT

A web page is adaptively transcribed and rendered at a client endpoint. A request for a web page is received, and full page content of the web page is obtained from a remote web server, including assembly of previously cached parts of the web page. The web page is transcribed according to prescribed rules. The prescribed rules are selected according to user preferences, the environmental factors and information learned from prior handling of the web page. The transcribed web page is rendered.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

This invention relates to web pages and, in particular to transcription of web pages.

Different individuals may be interested in different contents of the same web pages. Some individuals may not even care for information on the web pages that other individuals are interested in. Thus, it is worthless from a user experience point of view to provide individuals with information on web pages that is unnecessary, undue, and/or superfluous.

The Internet has been accredited with free information which may be sometimes dangerous and can have undesirable repercussions. There may be a need to filter the information. Typically, this is done through completely blocking some web sites. The blocking is based on some indexing of web-sites based on keywords etc. However, within a website some information is desirable and some is undesirable. Thus, complete blocking is a very extreme solution and may defeat the purpose of information flow.

### SUMMARY

According to exemplary embodiments, a method is provided for adaptively transcribing a web page at a client endpoint. A request for a web page is received from a user, and full page content of the web page is obtained from a remote web server, including assembly of previously cached parts of the web page. The web page is transcribed according to prescribed rules. The prescribed rules are selected according to user preferences, environmental factors and information learned from prior handling of the web page. The transcribed web page is rendered to the user that requested the web page.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a diagram of a network system for requesting web pages.

FIG. 2 shows a representation of how a web page is altered locally to a simplified page that enhances the user experience according to an exemplary embodiment.

FIG. 3 shows a representation of functional components incorporating user preferences, information regarding prior interactions and environmental factors to transcribe a web page by modifying a document object model presented by a browser according to exemplary embodiments.

FIG. 4 is a flow diagram depicting a method for transcribing a web page according to exemplary embodiments.

The detailed description explains exemplary embodiments, together with advantages and features, by way of example with reference to the drawings.

### DETAILED DESCRIPTION

The Internet provides users with access to a wide array of information. Some information may be undue or irrelevant, depending on the user. For example, within a corporate environment, a company may want its employees to not have access to the content on different web pages that are contrary to the company's business interests. Within a home environment, parents may not want their children to have access to content that is not appropriate to children, their religious and/or their social beliefs, etc.

The content of a web page desired by a user depends on the user's preferences, i.e., what the user would like to see on a web page. Further, these preferences can be different depending upon the state of the user (e.g., mood of the user), state of the environment (e.g., office, home), temporal factors (e.g., time of day), geographical factors (e.g., physical location of the user), event-driven factors (e.g., major events, natural disasters), etc. For example, a user “Jack” may be interested in obtaining world news in the morning at www.cnn.com/WORLD/ and personal finance information in the afternoon at www.cnn.com, in particular www.money.cnn.com/pf/index.html. In the evening, the user may be interested in obtaining news regarding sports and TV-entertainment at www.cnn.com. The user may also obtain information about the weather at a particular time every evening, e.g., 6:00 PM, at www.cnn.com/WEATHER/ before leaving for home. For this user, this pattern of web page viewing may be repeated every typical working day.

It is desirable to present an individual with a view of a web page that is conformant to the user's preferences, environment, time of day, present disposition, etc. Some companies offer this personalization (e.g., http://my.yahoo.com) based on preferences specified by the user. When the user signs in for this service, he or she is required to fill out a form describing his or her preferences from a list of topics provided by Yahoo. After that, any time the user logs in to http://my.yahoo.com, the user is presented with a customized web page that is in accordance with the information provided by the user when filling the preferences form. This static server side customization is not an appealing solution, as it there are several problems associated with this approach.

One problem with the current approach is that it lacks scalability. Server side personalization requires maintenance of preferences of each user. With the increase in the number of users accessing the site over time, the server supporting the site will require more and more resources (memory, network bandwidth) to operate efficiently.

Another problem with the current approach is that it may not be appealing to many users. Users are not always willing and are often reluctant to have their preferences maintained by a service provided by a company. Thus, it may be difficult to elicit specific information about user preferences from certain users.

Yet another problem with the current approach is that it is non-adaptive. Server side personalization is static and cannot adapt to dynamic factors affecting the preferences of the user, such as the time of day, the mental state of the user, the state of the current environment of the user, etc. This is because the web site customization is governed by the preferences specified by users when the users first sign in at the site. Any change in the customization can only happen when the users manually edit their preferences. For example, if in the original web page, there are sections on News, Stocks, Weather, Movies, Games, and in the preferences form the user specified interest in the News, Movies and Games sections, then each time the user logs in to the site, the user will be shown a customized web page with only three sections: News, Movies and Games. However, the user may only be interested in the Games section on a particular day, e.g., during the World Series. But, because the current approach is only based on the preferences specified by the user in advance and is not intelligent enough to have inferred/learned that the user is only interested in the Games section on a particular day, the user will still be shown the web page with all the three sections: News, Movies and Games.

Yet another problem with the current approach is that customization is restricted. Typically, based on the preferences specified by the user in terms of the contents of the original web page that are of interest, a customized web page is created which only has contents that match user preferences. There is no capability to customize the web page based on the inferred or learned preferences, in addition to the user's specified preferences. This is partly because the current approach is implemented at the server side, which prevents detailed user-specific visual transcription of web pages due to scalability requirements.

According to exemplary embodiments, a method and an apparatus are provided for transcription of web pages at the client side, such that the transcription is adaptive to changing preferences of user. This will enhance the user experience. Adaptive transcription of web pages by downgrading undesirable contents and upgrading desirable parts provides the user with an excellent experience that is responsive to the user's prior habits of use, state, environment and temporal factors.

According to exemplary embodiments, there are two approaches for user specific transcription: visual transcription and adaptive content synthesis. In visual transcription, web pages are transcribed before they are presented to the users such that in the new view, user-preferred fields of the page are emphasized, and undesired fields are visually downgraded. Visual downgrading can be achieved by erasing an object from the old view, with small provision to restore such items in a convenient manner, re-positioning of objects, e.g., placing preferred objects at the center of the screen whereas undesired are placed at the bottom of the screen, increasing the font size of preferred objects and reducing the font size of undesired objects, collapsing content into cascaded style sheet sections, and placing “fog” over parts or all of web pages. The user can “wipe off” the fog with a mouse. This action provides feedback on the expressed interests of users. Another way of visually downgrading may be achieved by placing a portion of the page content on a separate virtual page and replacing the portion of the page content with one or more hyperlinks on the transcribed web page. In adaptive content synthesis, objects corresponding to preferred contents from the same/different web pages are combined together, and a new webpage is created for the user dynamically, depending upon the preferred contents on different web pages a user is interested in. These two approaches may be used separately or in combination for web page transcription according toe exemplary embodiments.

According to exemplary embodiments, the web page transcriber is a client side solution sitting on the client's system. Additionally, the rules for visual transcription and content synthesis can be specified by the user, and/or learned over time, e.g., by observing internet access patterns, and/or provided by some third party, e.g., a corporation devising rules based on its business policies; parents devising rules on the contents of web sites accessible to their children, etc.

In today's web technology, CSS is used to identify/set attributes for page portions, using identifiers or classes. According to exemplary embodiments, a web page may be remodeled using Cascading Style Sheet (CSS) technology to preserve existing data but contain it differently, so that the exposure of the original data is appropriately “squashed” or hidden into collapsible areas that can still be tinkered with by the end user.

According to exemplary embodiments, new and re-visited web pages are handled without the encumbrance of a server. A web page transcriber may be deployed as add-on apparatus to the web browser, only with “policies” allowing a broader definition of how to trim or refactor any visited web page, not bound to a specific page concretely. The user is totally free to select or integrate web resources in whatever manner desired.

According to exemplary embodiments, a real-time contextual environment of the user is maintained based on the user's preferences, environment, mood, etc. together with learned preferences. Policy condition substitutes may be used for the CSS attributes provided by the visited web site. The content of the web page is not distorted or filtered out by default (though filtering is certainly possible). Instead, altering or inserting CSS definitions, content is collapsed into portions that afford the user the choice to still inspect the content, while being given a view enhanced by adjustments in the page content. In addition, uses may be protected from viewing undesirable material, much as certain active spyware, adware, malicious malware, and age-inappropriate content.

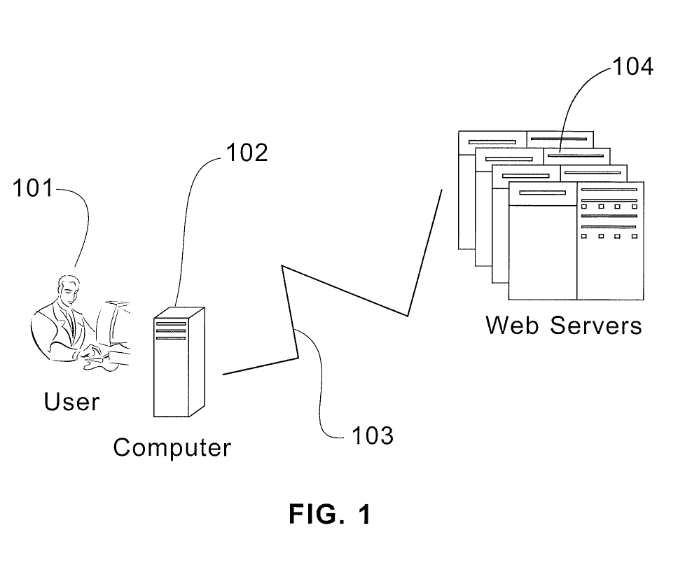

FIG. 1 illustrates shows a diagram of a network system for requesting web pages. A user 101 uses means, such as a computer 102 containing a web browser and Internet connectivity 103, to access one or more remote web servers 104.

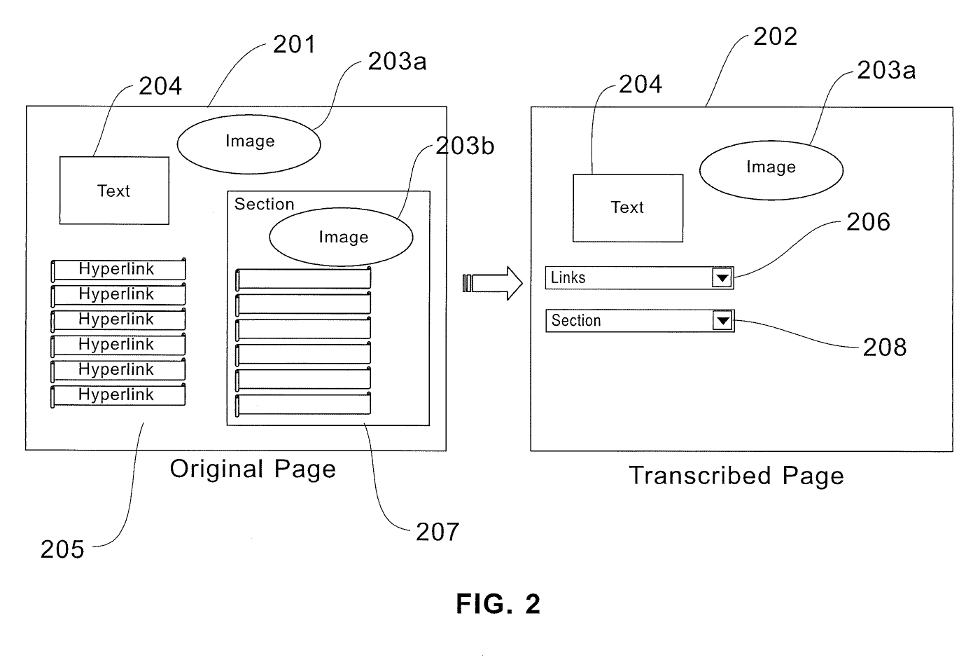

Referring to FIG. 2, which illustrates how a web page is altered locally to a simplified page that enhances the user experience according to an exemplary embodiment, the user would conventionally receive an original web page 201. The original web page 201 would include a plurality of various hypertext markup elements, such as images 203a and 203b, text 204, some comprised of hyperlinks 205 to other locations, and subsections 207 similar to the aforementioned elements. This complete rendition of the web page provides a rich but potentially overly complex web page when ultimately rendered from the document object model (DOM) of the loaded web page.

According to exemplary embodiments, the web page 201 is simplified through adaptive transcription to produce a curtailed representation 202 according to policy-managed alterations to the original DOM. For example, in an exemplary embodiment, some page components are not altered, such as the image 203a and text 204b. The stack of text (including hyperlinks) 205 is re-represented as a combo box 206, which maintains the needed links intact but simplifies the visual perception. A similar reduction for subsections 207 may similarly be done using combo box 208.

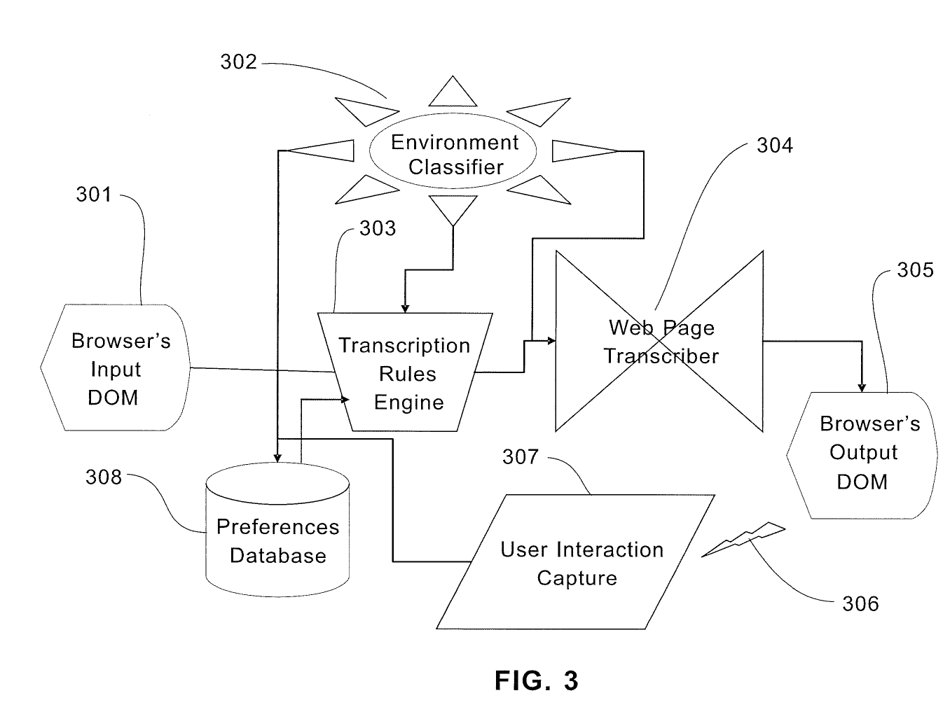

FIG. 3 shows a representation of functional components incorporating user preferences, information regarding prior interactions and environmental factors to transcribe a web page by modifying a document object model presented by a browser according to exemplary embodiments. The component shown in FIG. 3 may reside on the user's computer 102 (shown in FIG. 1). The apparatus depicted in FIG. 3 may be included as an add-on to the web browser in the computer 102. As shown in FIG. 3, a browser's input DOM component 301 receives a Document Object Model (DOM) of a web page loaded from a remote server by the web browser, and a browser's output DOM 305 component assembles the output of a web page transcriber 304 (described below) into the DOM that gets rendered by the browser into the web page that the user observes.

A user's interactions 306 with the browser may be captured via a user interaction capture component 307 and stored in a preferences database 308. The preferences database 308 includes information based on the user's own browser cache of frequently accessed web pages. Each web page can be parsed into its constituent objects, and the objects may be indexed with meta-data describing its contents, frequency with which it is accessed by the user, time of the day of access, etc. The database 308 can be updated as new information about the individual access patterns is observed by the system (306, 307).

The environment classifier 302 contains information regarding the time of day, office/home, user state (mood), etc. The environment can be learned by observing current applications running on the computer, by the IP address of the computer, etc. The environmental information may be stored in the preferences database 308.

The transcription rules engine 303 contains different rules for transcribing web pages based on the information stored in the preferences database 308 and/or information delivered directly, e.g., from the environment classifier 302. The rules specify the contents of the transcribed web pages and the page layout. There are also rules for cross transcription using “preferred” objects from different web pages and presenting them in a visually rich manner to the user.

The web page transcriber 304 takes as input the rules from the transcription rules engine 303, environmental information from the environment classifier 302 and web pages and creates transcribed web pages that are then presented to the user.

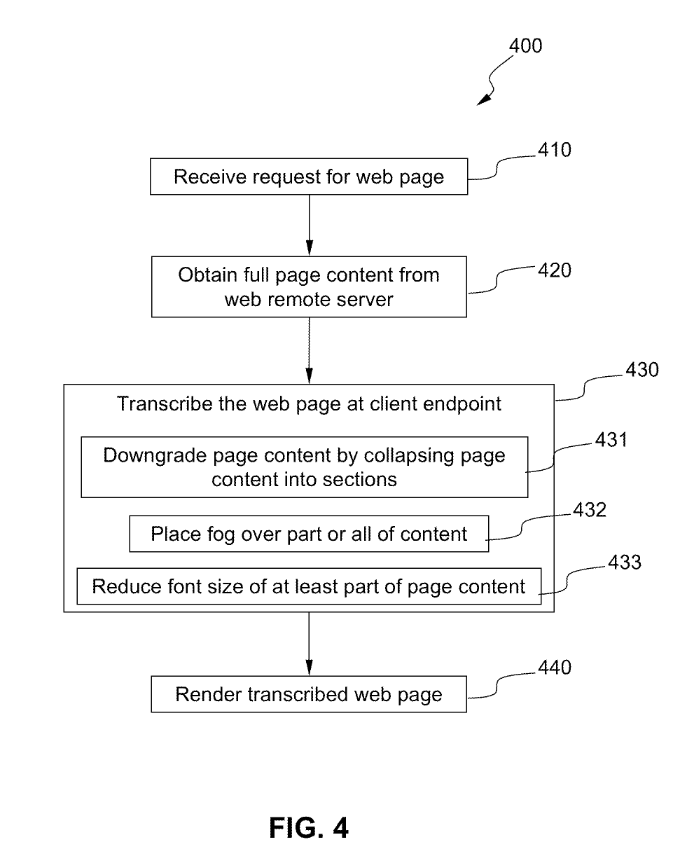

FIG. 4 illustrates a method 400 for adaptively transcribing a web page according to exemplary embodiments. A request for a web page is received, i.e., a URL is received, from a user at step 410. The browser connects with the remote web server and obtains the full page content, including assembly of parts previously cached, at step 420. Before the browser renders the result 301, the web page transcriber 304 modifies the web page at step 430 according to prescribed rules selected based on user preferences, environmental factors, and information learned from prior handling. The net result is rendered to the user at step 440 as 305 (FIG. 3).

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagram depicted herein is just an example. There may be many variations to these diagrams or the steps (or operations) described therein without departing from the spirit of the invention. For instance, the steps may be performed in a differing order, or steps may be added, deleted or modified. All of these variations are considered a part of the claimed invention.

While exemplary embodiments have been described, it will be understood that those skilled in the art, both now and in the future, may make various improvements and enhancements which fall within the scope of the claims which follow. These claims should be construed to maintain the proper protection for the invention first described.

1. A method for adaptively transcribing a web page, comprising:
receiving a request for a web page from a user;
obtaining full page content of the web page from a remote web server, including assembling previously cached parts of the web page;
transcribing the web page according to prescribed rules selected according to user preferences, environmental factors and information learned from prior handling of the web page, the environmental factors including a state of the environment in which the user is located, wherein transcribing includes downgrading page content by at least one of:
placing fog over at least part of the page content; and
reducing a font size of some page content; and
rendering the transcribed web page to the user, wherein the steps of receiving, obtaining, transcribing, and rendering are performed at the client endpoint.

2. A method for adaptively transcribing a web page, comprising:
receiving a request for a web page from a user;
obtaining full page content of the web page from a remote web server, including assembling previously cached parts of the web page;
transcribing the web page according to prescribed rules selected according to user preferences, environmental factors and information learned from prior handling of the web page, the environmental factors including a state of the environment in which the user is located, wherein transcribing includes downgrading page content by collapsing the page content into sections; and
rendering the transcribed web page to the user, wherein the steps of receiving, obtaining, transcribing, and rendering are performed at the client endpoint.

3. The method of claim 1, wherein the prescribed rules are further selected according to at least one of temporal factors, user location, and connectivity information.

4. A method for adaptively transcribing a web page, comprising:
receiving a request for a web page from a user;
obtaining full page content of the web page from a remote web server, including assembling previously cached parts of the web page;
transcribing the web page according to prescribed rules selected according to user preferences, environmental factors and information learned from prior handling of the web page, the environmental factors including a state of the environment in which the user is located, wherein the transcribing includes upgrading some page content by at least one of:
placing a preferred portion of the page content in a center portion of the page; and
increasing the font size of a preferred portion of the page content; and
rendering the transcribed web page to the user, wherein the steps of receiving, obtaining, transcribing, and rendering are performed at the client endpoint.
